(19) United States
(12) Patent Application Publication
(10) Pub. No.: US 2010/0037102 A1
(43) Pub. Date: Feb. 11, 2010

(54) FAULT-TOLERANT NON-VOLATILE BUDDY MEMORY STRUCTURE

(75) Inventors: Yiran Chen, Eden Prairie, MN (US); Hai Li, Eden Prairie, MN (US); Harry Hongyue Liu, Maple Grove, MN (US); Alan Xuguang Wang, Eden Prairie, MN (US); Song S. Xue, Edina, MN (US)

Correspondence Address: Fellers, Snider, Blankenship, Bailey & Tippens, PC;(Seagate Technology LLC), 100 North Broadway, Suite 1700, Oklahoma City, OK, 73102-8820, US

(73) Assignee: SEAGATE TECHNOLOGY LLC, Scotts Valley, CA (US)

(21) Appl. No.: 12/269,535

(22) Filed: Nov. 12, 2008

Related U.S. Application Data
(60) Provisional application No. 61/087,203, filed on Aug. 8, 2008.

(51) Int. Cl. G06F 11/16; G06F 11/00; G06F 12/08; G06F 12/00

(52) U.S. Cl. 714/42; 711/202; 711/118; 711/104; 714/E11.054; 714/E11.055; 711/E12.001; 711/E12.017

(57) ABSTRACT

Various embodiments of the present invention are generally directed to an apparatus and method for providing a fault-tolerant non-volatile buddy memory structure, such as a buddy cache structure for a controller in a data storage device. A semiconductor memory array of blocks of non-volatile resistive sense memory (RSM) cells is arranged to form a buddy memory structure comprising a first set of blocks in a first location of the array and a second set of blocks in a second location of the array configured to redundantly mirror the first set of blocks. A read circuit decodes a fault map which identifies a defect in a selected one of the first and second sets of blocks and concurrently outputs data stored in the remaining one of the first and second sets of blocks responsive to a data read operation upon said buddy memory structure.

### RELATED APPLICATIONS

This application makes a claim of domestic priority under 35 U.S.C. §119(e) to U.S. Provisional Patent Application No. 61/087,203 filed Aug. 8, 2008.

### BACKGROUND

Data storage devices generally operate to store and retrieve data in a fast and efficient manner. Some storage devices utilize a semiconductor array of solid-state memory cells to store individual bits of data. Such memory cells can be volatile or non-volatile.

As will be appreciated, volatile memory cells generally retain data stored in memory only so long as operational power continues to be supplied to the device. Non-volatile memory cells generally retain data stored in memory even in the absence of the application of operational power.

So-called resistive sense memory (RSM) cells can be configured to have different electrical resistances to store different logical states. The resistance of the cells can be subsequently detected during a read operation by applying a read current and sensing a signal in relation to a voltage drop across the cell. Exemplary types of RSM cells include resistive random access memory (RRAM), magnetic random access memory (MRAM), spin-torque transfer random access memory (STTRAM or STRAM), phase-change random access memory (PRAM), etc.

### SUMMARY

Various embodiments of the present invention are generally directed to an apparatus and method for providing a fault-tolerant non-volatile buddy memory structure, such as a buddy cache structure for a controller in a data storage device.

In accordance with some embodiments, the apparatus generally comprises a semiconductor memory array of blocks of non-volatile resistive sense memory (RSM) cells arranged to form a buddy memory structure comprising a first set of blocks in a first location of the array and a second set of blocks in a second location of the array configured to redundantly mirror the first set of blocks; and a read circuit which decodes a fault map which identifies a defect in a selected one of the first and second sets of blocks and concurrently outputs data stored in the remaining one of the first and second sets of blocks responsive to a data read operation upon said buddy memory structure.

In accordance with other embodiments, the apparatus generally comprises a data storage device comprising a semiconductor memory array of blocks of non-volatile resistive sense memory cells; a controller configured to direct a transfer of data between said memory array and a host device; and a non-volatile cache coupled to the controller, the cache characterized as a buddy cache structure comprising a first set of blocks in a first location of the cache and a second set of blocks in a second location of the cache configured to redundantly mirror the first set of blocks, wherein the cache further generates a fault map which identifies a defect in a selected one of the first and second sets of blocks to direct use of the remaining one of the first and second sets of blocks for caching by the controller.

In accordance with further embodiments, a method generally comprises providing a non-volatile resistive sense memory buddy caching structure comprising a first set of blocks in a first location of the structure and a second set of blocks in a second location of the structure; redundantly writing data to both the first and second sets of blocks so that they mirror each other; maintaining a fault map and a buddy map wherein the fault map indicates which blocks of said first and second sets of blocks are operational and the buddy map associates the respective first and second sets of blocks to compensate for potential faults; and outputting data upon a request by decoding the fault map and the buddy map to return the appropriate block data.

These and various other features and advantages which characterize the various embodiments of the present invention can be understood in view of the following detailed discussion in view of the accompanying drawings.

### BRIEF DESCRIPTION OF THE DRAWINGS

FIG. 1 is a generalized functional representation of an exemplary data storage device constructed and operated in accordance with various embodiments of the present invention.

FIG. 2 shows circuitry used to read data from and write data to a memory array of the device of FIG. 1.

FIG. 3 generally illustrates a manner in which data are written to a memory cell of the memory array.

FIG. 4 generally illustrates a manner in which data are read from the memory cell of FIG. 3.

FIG. 5 shows an exemplary cache structure of the device of FIG. 1 in accordance with various embodiments of the present invention.

FIGS. 6A and 6B respectively illustrate set-level buddying and row-level buddying for the cache structure of FIG. 5.

FIG. 7 shows an exemplary data format for the cache structure of FIG. 5.

FIG. 8 illustrates multiplexed divisions of buddied cache blocks of FIG. 7

FIG. 9 illustrates a timing path flow during operation of buddied cache blocks.

FIG. 10 is a flow chart for a BUDDY CACHING routine illustrative of steps carried out in accordance with various embodiments.

### DETAILED DESCRIPTION

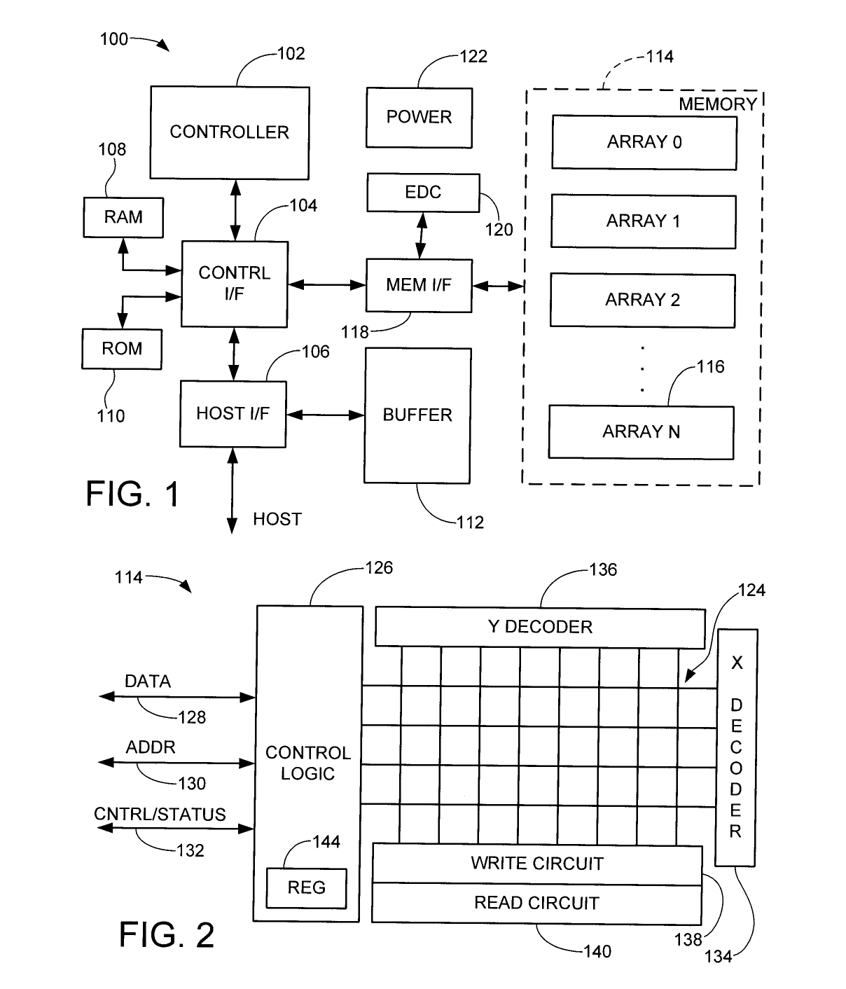

FIG. 1 provides a functional block representation of a data storage device 100 constructed and operated in accordance with various embodiments of the present invention. The data storage device is contemplated as alternatively comprising a solid state drive (SSD), a general memory system, or a portable non-volatile memory storage device. It will be appreciated, however, that such characterizations of the device 100 are merely for purposes of illustration and are not limiting to the claimed subject matter.

Top level control of the device 100 is carried out by a suitable controller 102, which may be a programmable or hardware based microcontroller. The controller 102 communicates with a host device via a controller interface (I/F) circuit 104 and a host I/F circuit 106. Local storage of requisite commands, programming, operational data, etc. is provided via random access memory (RAM) 108 and read-only memory (ROM) 110. A buffer 112 serves to temporarily store input write data from the host device and readback data pending transfer to the host device, as well as to facilitate serialization/deserialization of the data during a transfer operation. The buffer can be located in any suitable location, including in a portion of the array.

A memory space is shown at 114 to comprise a number of memory arrays 116 (denoted Array 0-N), although it will be appreciated that a single array can be utilized as desired. Each array 116 preferably comprises a block of semiconductor memory of selected storage capacity. Communications between the controller 102 and the memory space 114 are coordinated via a memory (MEM) I/F 118. As desired, on-the-fly error detection and correction (EDC) encoding and decoding operations are carried out during data transfers by way of an EDC block 120.

While not limiting, in an embodiment the various circuits depicted in FIG. 1 are arranged as a single chip set formed on one or more semiconductor dies with suitable encapsulation, housing and interconnection features (not separately shown for purposes of clarity). Input power to operate the device is handled by a suitable power management circuit 122 and is supplied from a suitable source such as from a battery, AC power input, etc. Power can also be supplied to the device 100 directly from the host such as through the use of a USB-style interface, etc.

Any number of data storage and transfer protocols can be utilized, such as logical block addressing (LBAs) whereby data are arranged and stored in fixed-size blocks (such as 512 bytes of user data plus overhead bytes for EDC codes, sparing, header information, etc). Host commands can be issued in terms of LBAs, and the device 100 can carry out a corresponding LBA-to-PBA (physical block address) conversion to identify and service the associated locations at which the data are to be stored or retrieved.

FIG. 2 provides a representation of selected aspects of the memory space 114 of FIG. 1. Data are stored in each array as an arrangement of rows and columns of memory cells 124, accessible by various row (word) and column (bit) lines. The actual configurations of the cells and the access lines thereto will depend on the requirements of a given application. Generally, however, it will be appreciated that the various control lines will include enable lines that selectively enable and disable the respective writing and reading of the value(s) of the individual cells.

Control logic 126 receives and transfers data, addressing information and control/status values along multi-line bus paths 128, 130 and 132, respectively. X and Y decoding circuitry 134, 136 provide appropriate switching and other functions to access the appropriate cells 124. As desired, adjacent arrays can be configured to share a single Y (row) decoder 136 to reduce RC delay effects along an associated word line.

A write circuit 138 represents circuitry elements that operate to carry out write operations to write data to the cells 124, and a read circuit 140 correspondingly operates to obtain readback data from the cells 124. Local buffering of transferred data and other values can be provided via one or more local registers 144. At this point it will be appreciated that the circuitry of FIG. 2 is merely exemplary in nature, and any number of alternative configurations can readily be employed as desired depending on the requirements of a given application.

The memory cells 124 are characterized as so-called resistive sense memory (RSM) cells. As used herein, RSM cells are generally described as cells configured to have different electrical resistances which are used to store different logical states. The resistance of the cells can be subsequently detected during a read operation by applying a read current and sensing a signal in relation to a voltage drop across the cell. Exemplary types of RSM cells include resistive random access memory (RRAM), magnetic random access memory (MRAM), spin-torque transfer random access memory (STTRAM or STRAM), phase-change random access memory (PRAM), etc.

Advantages of RSM cells include the fact that no floating gate is provided, so no erase operation is necessary prior to the writing of new data to an existing set of cells as in the case with non-volatile memory cell constructions such as EEPROM, flash, etc. Also, write and read power consumption requirements are substantially reduced, significantly faster write and read times can be achieved, and substantially no wear degradation is observed as compared to floating gate cells, which generally have a limited write/erase cycle life.

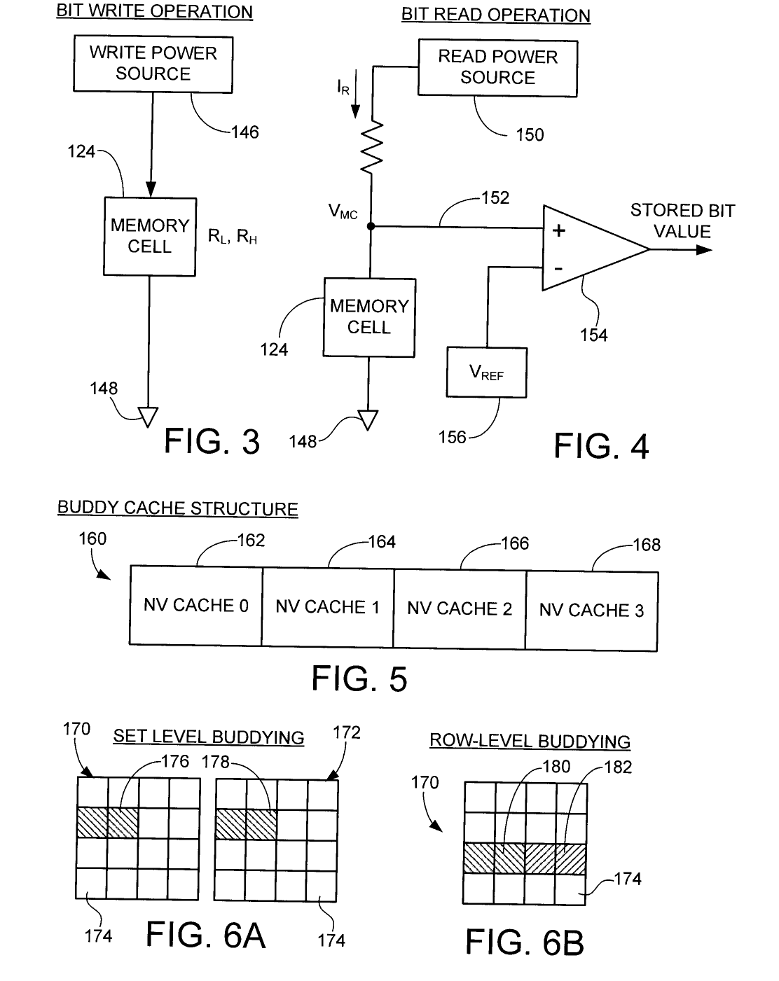

Data are written to the respective RSM memory cells 124 as generally depicted in FIG. 3. Generally, a write power source 146 applies the necessary input (such as in the form of current, voltage, magnetization, etc.) to configure the memory cell 124 to a desired state. It can be appreciated that FIG. 3 is merely a representative illustration of a bit write operation.

The configuration of the write power source 146, memory cell 124, and reference node 148 can be suitably manipulated to allow the writing of data to the array. Depending on the orientation of the applied power, the cell 124 may take either a relatively low resistance (R_{L}) or a relatively high resistance (R_{H}). While not limiting, exemplary R_{L} values may be in the range of about 100 ohms (Ω) or so, whereas exemplary R_{H} values may be in the range of about 100 KΩ or so. These values are retained by the respective cells until such time that the state is changed by a subsequent write operation. While not limiting, in the present example it is contemplated that a high resistance value (R_{H}) denotes storage of a logical 1 by the cell 124, and a low resistance value (R_{L}) denotes storage of a logical 0.

The logical bit value(s) stored by each cell 124 can be determined in a manner such as illustrated by FIG. 4. A read power source 150 applies an appropriate input (e.g., a selected read voltage) to the memory cell 124. The amount of read current I_{R} that flows through the cell 124 will be a function of the resistance of the cell (R_{L} or R_{H}, respectively). In the case of STRAM, as well as other types of memory configurations such as RRAM, the read current magnitude will be generally be significantly lower than the write current magnitude utilized to set the storage state of the bit. The voltage drop across the memory cell (voltage V_{MC}) is sensed via path 152 by the positive (+) input of a comparator 154. A suitable reference (such as voltage reference V_{REF}) is supplied to the negative (−) input of the comparator 154 from a reference source 156.

The reference voltage V_{REF} is preferably selected such that the voltage drop V_{MC} across the memory cell 124 will be lower than the V_{REF} value when the resistance of the cell is set to R_{L}, and will be higher than the V_{REF} value when the resistance of the cell is set to R_{H}. In this way, the output voltage level of the comparator 154 will indicate the logical bit value (0 or 1) stored by the memory cell 124. The reference voltage can be generated and supplied externally, or can be generated locally using dummy reference cells or a self-reference operation, as desired.

In accordance with various embodiments, a buddy memory structure is utilized to promote enhanced reliability and availability of a memory space. Generally, buddying refers to an associational scheme whereby a first group (set, division) of memory blocks in a first region of memory are assigned, related, or otherwise associated with at least one additional group of memory blocks in a different region of the memory so that data are mirrored (stored redundantly to contain substantially the same data) in the respective groups of blocks. There can be any desired number of “buddied” sets of blocks, such as four sets of buddied blocks, etc.

The number of blocks in each buddied set of blocks can similarly be any suitable number. In some embodiments, this is set to a constant value, such as four blocks in each set. Other numbers of blocks in each set can be used, however, including a single block or a large number of blocks. The number of blocks in each buddied set can be selected so as to correspond to an entire row (or column) in the associated memory.

Different sets of buddied blocks can have different numbers of blocks; for example, a first set of four buddied blocks can each have four blocks therein (for a total of 4×4=16 total blocks), while a second set of four buddied blocks can each have a different number of blocks (such as eight blocks for a total of 4×8=32 total blocks, etc).

The number of blocks in each buddied set can further be selectively altered depending on the requirements of a given application. For example, a segmented input buffer arrangement can be used whereby a segment in the buffer is assigned to accommodate input data from a host, with the size of the segment defined in relation to the size (amount) of the input data. Buddied sets of blocks can thus be additionally established for the size of the defined segment.

Generally, the use of buddied sets of blocks allows an entire set of “functional” blocks to be presented for use, even in the presence of defects. That is, even if a large number of the individual blocks across a given set of buddied blocks are defective, so long as there are sufficient non-defective blocks to make up an entire set of functional blocks, data access operations can still take place. This is true even if each block is physically located in a separate region of the memory.

FIG. 5 illustrates an exemplary buddy memory structure 160 utilized by the device 100 in accordance with various embodiments of the present invention. In some embodiments, the structure 160 is characterized as a buddy cache which is incorporated into the buffer 112 (FIG. 1) and used by the controller 102 to temporarily cache data and other information during data transfer operations between the memory space 114 and the host device. In other embodiments, the structure 160 is alternatively characterized a portion of the main non-volatile memory space 114 to provides enhanced data protection for the data stored in that portion of the memory space. Thus, the following description of the structure 160 in terms of a buddy cache structure serves to illustrate particular embodiments of the present invention, and is not limiting to the scope of the claimed subject matter.

The buddy cache structure 160 is shown to comprise NV cache regions 162, 164, 166 and 168 (also denoted as NV Cache 0-3). In some embodiments, each cache region constitutes a separate physical location, or region of memory, including but not limited to separate physical arrays of RSM data cells. The respective regions 162, 164, 166 and 168 combine to provide a cache memory space with built-in redundancy.

As noted above, the buddy cache structure 160 enables the merging of multiple non-faulty portions of two or more memory blocks to yield a fully functional memory block. This eliminates the need to reject blocks of memory from usage (during manufacturing or subsequent field use) because of the presence of defective memory cells, thereby increasing manufacturing yields and field-level reliability.

Generally, the regions of FIG. 5 are each divided up into k divisions of blocks of a selected number of RSM memory cells 124. In some embodiments, data are concurrently (i.e., simultaneously or sequentially) written to blocks in each of the regions 162, 164, 166 and 168 during a data write operation, thereby providing redundant storage of the input data. If a particular set of blocks is found to have a defect, the data are stored (and subsequently retrieved) from the associated buddy blocks in the remaining region(s). While four (4) blocks are depicted in FIG. 5, it will be appreciated that fewer or more can be used as desired. Moreover, some sets of blocks can have more sets of associated buddy blocks than others, or each set of blocks can have the same number of associated buddy blocks, depending on the requirements of a given application.

FIG. 6A illustrates so-called set-level buddying, which will be explained as follows. FIG. 6A shows two portions of the buddy cache structure 160, denoted as 170 and 172. Without limitation, the first portion 170 can correspond to a selected first location in the buddy cache structure 160 (e.g., the first region 162 in FIG. 5) and the second portion 172 can correspond to a selected second location in the buddy cache structure 160 (e.g., the second region 164 in FIG. 5). Each of the portions 170, 172 includes a number of blocks 174, each comprising an individually addressable block of a selected number of RSM memory cells 124.

The term set-level buddying refers to an association scheme whereby a first set (division) of blocks 176 in the first portion 170 (said set including a single block or multiple blocks) is buddied to a second set of blocks 178 in the second portion 172. It will be noted that in one embodiment the respective numbers of blocks 174 in the sets 176, 178 constitute less than a full row of blocks in each portion. The number of blocks 174 in each set 176, 178 can be selected to be any suitable number, including a number of blocks that span multiple rows (or columns) of blocks in the respective portions 170, 172. Also, while the respective sets 176, 178 are shown to be at the same row and column coordinates in the respective portions 170, 172, this is also not necessarily required.

FIG. 6B illustrates so-called row-level buddying, in which a first set of blocks 180 in the first portion 170 (said set including a single block or multiple blocks) is buddied with a second set of blocks 182 also located in the first portion 170. In the depicted embodiment, the first set of blocks 180 and the second set of blocks 182 are buddied in the same row. Other conventions can readily be used, including buddying within a sector, buddying within a column, etc.

While only two buddy sets are shown in FIGS. 6A and 6B (i.e., 176/178 and 180/182), it will be appreciated that any number of buddy sets can be mutually associated as desired. As noted above, such buddying allows continued operation of that particular address of the cache structure 160; for example, should a defect be associated with the set of blocks 176 of FIG. 6A, the corresponding set of blocks 178 can be utilized in lieu thereof without a loss of performance or cache capacity.

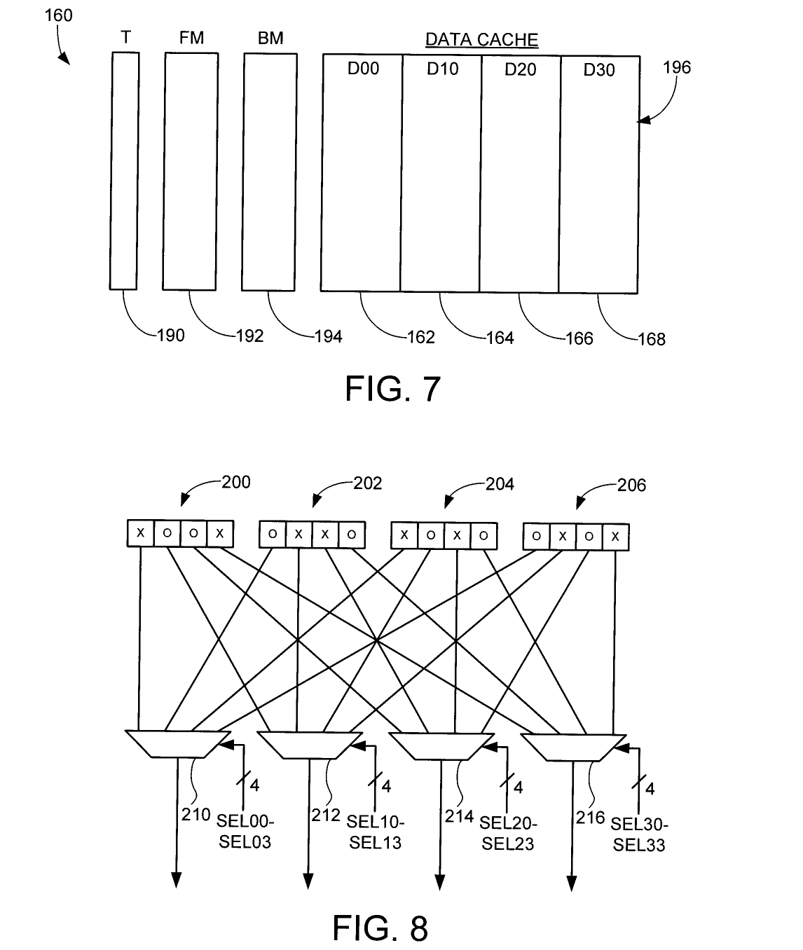

FIG. 7 provides a generalized representation of a data format for the buddy cache structure 160 of FIG. 5. The format includes a tag field 190, a fault map 192, a buddy map 194 and a data cache field 196. Generally, the tag field 190 stores tag information to identify the associated contents stored in cache for a particular entry in the cache.

For example, the tag field 190 can identify the contents stored in the cache field 196 and the associated native address thereof (LBA, etc.) in the memory space 114. Any number of conventions can be used for cache data tracking as desired. Generally, the tags are used to promote cache hits so that requested data can be returned from cache rather than requiring an access operation upon the memory space 114.

The fault map 192 provides defect information associated with the buddied cache blocks. The buddy map serves as a pointer to identify the locations of the buddied cache blocks for a given block (or division). The cache field 196 constitutes the cache portions of the respective cache regions 162, 164, 166 and 168 (respectively denoted D00, D10, D20 and D30).

Generally, the cache blocks are divided into k divisions. To denote faulty (defective) blocks and defective tag fields, k+1 fault bits are used in the fault map 192. Each bit denotes whether the corresponding cache division or tag field is faulty or not (i.e., defective or non-defective). Every cache block has its own entry in the fault map 192.

A buddy map is also created to store the index of the buddy block(s) associated with each faulty block. When set-level buddying is used (FIG. 6A), the number of bits in each buddy map entry in the buddy field 194 can be set to log n, where n is the number of ways for the cache structure. As will be recognized, a one-way cache allows every set of blocks in the main memory 114 to be mapped to every set of blocks in the cache structure; a four-way cache on the other hand, for example, generally divides the blocks of data in the main memory space 114 into four groups and the data from each group is provided to a different portion, or way, of the cache. It will be appreciated that one-way cache arrangements provide relatively simple complexity, whereas multi-way cache arrangements can provide overall faster performance but at the cost of relatively higher complexity.

When row-level buddying is utilized (FIG. 6B), the number of bits in each buddy map entry can be set to log m, where m is the number of cache blocks in the same row. Regardless of scheme, it will be appreciated that for a fully operational cache block, its buddy map entry may simply point to itself.

When the faulty bits are operational but buddy bits are faulty, a fully operational cache block can still be recorded properly in the fault bits regardless of the status of the faulty buddy index. However, if the tag or any of the data divisions is faulty, the associated cache blocks may require deallocation from use by the cache structure 160 by marking the associated cache blocks as unusable.

When the fault bits are faulty but the buddy index is not faulty, as long as one of the fault bits is not faulty, the cache blocks can be marked as not usable, such as by assigning the buddy index to itself and assigning the functional faulty bit to “faulty.” However, if there are no operational faulty bits, it may be advantageous to deallocate the entire set of blocks. Similarly, when both the fault map and the buddy map are faulty for a given set of buddied blocks, the entire set of blocks may require deallocation.

The foregoing conditions are summarized in Table 1 below.

TABLE 1

| Fault Map | Buddy Map | Cache Block | Outcome |
|---|---|---|---|
| No faulty bits | No faulty bits | Don't care | Cache blocks usable |
| No faulty bits | At least one | No faulty bits | Cache blocks usable |
| | faulty bit | | |
| No faulty bits | At least one | At least one | Deallocate blocks |
| | faulty bit | faulty bit | |
| <k + 1 faulty bits | No faulty bits | Don't care | Deallocate blocks |
| <k + 1 faulty bits | At least one | Don't care | Deallocate blocks |
| | faulty bit | | |
| All bits faulty | Don't care | Don't care | Deallocate blocks |

To buddy multiple sets of cache blocks, a multiplexing operation can be implemented such as set forth by FIG. 8. Buddied divisions (sets) of blocks are denoted at 200, 202, 204 and 206, respectively, for a four-way cache design. An X denotes that the associated block has been identified as having a fault, and an O denotes that the associated block is non-defective.

Connection lines (shown in straight line fashion for convenience) interconnect the buddied blocks to an array of multiplexors 210, 212, 214 and 216. Each multiplexor includes an associated number of selection lines (e.g., SEL00, SEL01, SEL02 and SEL03 for multiplexor 210, etc.) which control the output of the associated blocks. The selection lines are generated by a detection circuit (not shown in FIG. 8) which identifies the correct source for each division in relation to the fault map and buddy map entries, as discussed above. Generally, the selection signals can be expressed as SELij, where i=1 to k (k is the total number of divisions) and j=1 to n (n is the total number of cache blocks in each row or set).

For a given cache entry, the inputs to the decoder can include the buddy map, the fault map, a “cache hit” signal, and an original selection signal (which can be generated internally) to denote the data are valid and the tag matches an input address.

When reading data from the cache structure 160, the decoder can generate the selection signal to pick up the division from the cache block having the correct division. In such a cache, the tag fields of buddied cache block can have the same value. When writing data to the cache structure 160, all cache blocks buddied together can be written with the same values concurrently (either simultaneously or successively). It will be noted that the data write operation may require two (or more) successively consecutive writing operations if the cache design does not support writing multiple blocks simultaneously.

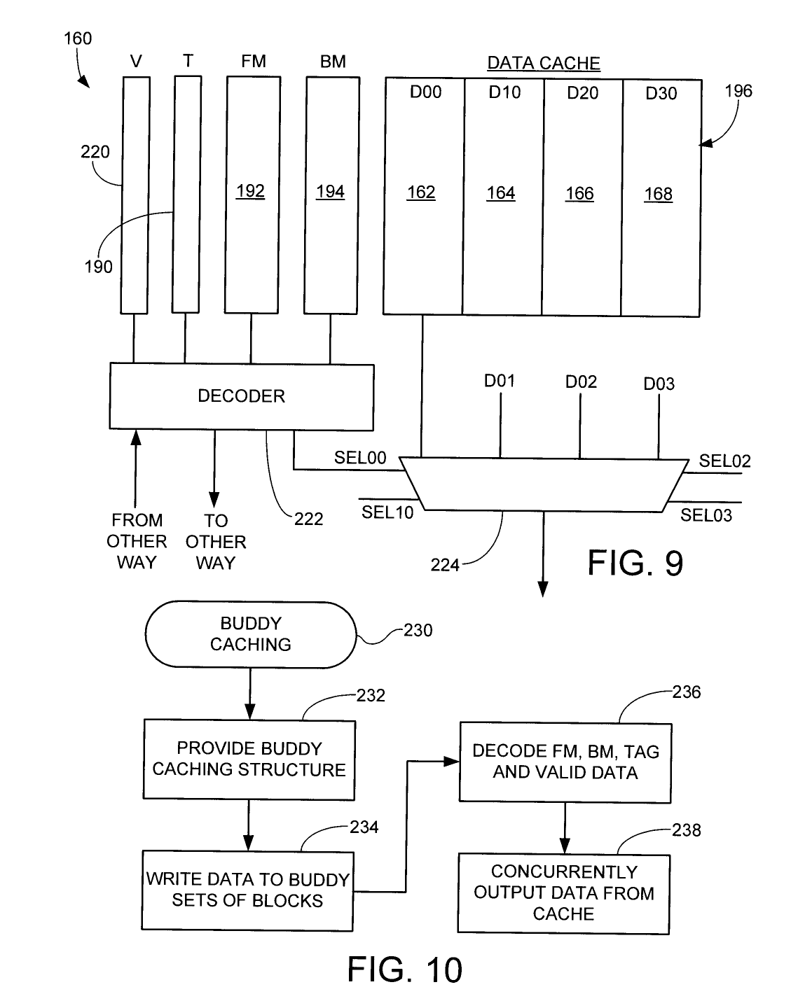

It will be appreciated that while the aforedescribed buddy cache structure may add complexity to the caching scheme over a conventional caching arrangement, such does not necessarily increase access time required to obtain data from the cache. FIG. 9 generally shows the data format of FIG. 7 with an additional leading valid field 220. The valid field 220 can be used to store a valid data flag, such as to identify dirty or older-version data in the cache.

When a cache access operation is received, a decoder circuit 222 accesses the associated fault map, buddy map and valid data concurrently with a conventional accessing of the tag data and cache blocks. More specifically, the operation of the decoder circuit 222 is executed along the tag access path, which may be typically faster than the cache block access path.

Accordingly, any processing delay required to identify an appropriate selection line and provide the same to an output selection multiplexor 224 can be masked by the time required to access the cache blocks. In a set-level buddying scheme, multiplexor 224 is connected to cache block portions D00, D01, D02 and D03 as discussed in relation to FIG. 8. As required, the decoder 222 can communicate with other decoders associated with other ways utilized during set-level buddying, as shown.

In some embodiments, data write operations to the cache structure 160 similarly utilize a decoding of at least the fault and buddy maps to identify appropriate locations to which data can be written to the cache. As desired, a write/read-verify operation can be carried out to ensure proper writing of the data at the conclusion of each write operation. Newly discovered defects (e.g., grown defects) result in updates to the fault map and, as required, the buddy map. If the read-verify operation shows the given sets of blocks to require deallocation, the data can also be written to a new location in the cache.

It will be appreciated that cache buddying as exemplified herein might increase the likelihood of a cache miss as a result of less cache space available to provide cache hits as compared to conventional non-buddied arrangements. This is countered, however, by the fact that the buddy caching scheme provides efficient and effective fault tolerance through redundancies for cache lines that would otherwise be deallocated as a result of a defect. As a result, cache availability and reliability is significantly improved.

The foregoing embodiments can be readily incorporated as a portion of the main memory of the space 114, constructed across one or more of the individual arrays 116 to provide enhanced data storage availability and reliability. Additional levels of fault protection, including the use of ECC codes, etc., can be readily incorporated to protect both the stored data as well as the respective fault and buddy maps, etc.

FIG. 10 provides a flow chart for a BUDDY CACHING routine 230, generally representative of steps carried out in accordance with various embodiments of the present invention. A buddy cache structure is initially provided at step 232, such as the aforementioned structure 160 discussed above. Data are written to the structure at step 234. This can include data mirroring of the input data to the respective sets of buddied blocks in a concurrent fashion, such as simultaneously or successively.

In some embodiments, data are written to the structure as a result of a data write operation in which data are presented for writing to a data storage array, and temporarily cached in the cache structure pending said write operation. In other embodiments, the data are written to the cache structure as a result of a data read operation in which data are retrieved from a data storage array pending transfer to a host device. In other embodiments, the data are generated by the controller and cached pending further usage by the controller. In each of these cases, tag data are generated and stored for the data in the cache, such as in the tag field 190 (FIG. 9).

In some embodiments, a next available cache line hierarchy is used so that the input data are placed in the next available cache entry location. The fault map (FM) and buddy map (BM) data can be consulted initially to determine such availability. Moreover, should a defect be detected during the write operation, such as during a read/write verify cycle, the FM and BM data can be updated accordingly. If the error is sufficient to require deallocation of the selected cache line (see e.g., Table 1), the data are written to the next available location in the cache.

Data are next read back from the cache as generally shown at steps 236 and 238 in FIG. 10. This is generally carried out as discussed above such and as set forth by FIG. 9. In some embodiments, this includes a decoding of the respective valid, tag data and FM and BM data to identify which of the buddied locations in the cache blocks should be accessed, step 236, and the concurrent outputting of the data from the associated location at step 238.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. An apparatus comprising:
a semiconductor memory array of blocks of non-volatile resistive sense memory (RSM) cells arranged to form a buddy memory structure comprising a first set of blocks in a first location of the array and a second set of blocks in a second location of the array configured to redundantly mirror the first set of blocks; and
a read circuit which decodes a fault map which identifies a defect in a selected one of the first and second sets of blocks and concurrently outputs data stored in the remaining one of the first and second sets of blocks responsive to a data read operation upon said buddy memory structure.

2. The apparatus of claim 1, further comprising a write circuit which concurrently writes input data to the respective first and second sets of blocks responsive to a data write operation, said input data subsequently output by the read circuit.

3. The apparatus of claim 1, wherein the read circuit comprises a decoder circuit which decodes the fault map to identify a defective set of blocks in the buddy cache structure and which decodes a buddy map to identify a corresponding set of non-defective blocks and to which data at a selected tag address are stored.

4. The apparatus of claim 3, wherein the read circuit further comprises a multiplexor coupled to the decoder circuit which selectively outputs said data from the non-defective blocks responsive to the decoder circuit.

5. The apparatus of claim 1, wherein the buddy memory structure is characterized as a cache memory for a controller, the cache memory used to cache data during transfers of said data between a non-volatile data memory array and a host device.

6. The apparatus of claim 1, wherein the buddy memory structure forms a portion of a non-volatile data storage space of a portable data storage device, and wherein cached data received from a host device are moved into the buddy memory structure from an input buffer of the data storage device.

7. The apparatus of claim 1, wherein the semiconductor memory array comprises at least a first module and a second module, and wherein the buddy cache structure uses set-level buddying such that the first set of blocks is located in the first module and the second set of blocks is located in the second module at a common location with respect to the first set of blocks in the first module.

8. The apparatus of claim 1, wherein the buddy cache structure uses row-level buddying such that the first and second sets of blocks are located in a common row in the memory array.

9. The apparatus of claim 1, wherein the RSM cells each comprise a spin-torque transfer random access memory (STRAM) cell.

10. The apparatus of claim 1, wherein the RSM cells each comprise a resistive random access memory (RRAM) cell.

11. The apparatus of claim 1, wherein the buddy memory structure further comprises a third set of blocks in a third location of the array configured to redundantly mirror the first set of blocks.

12. An apparatus comprising:
a semiconductor memory array of blocks of non-volatile resistive sense memory cells;
a controller configured to direct a transfer of data between said memory array and a host device; and
a non-volatile cache coupled to the controller, the cache characterized as a buddy cache structure comprising a first set of blocks in a first location of the cache and a second set of blocks in a second location of the cache configured to contain the same data as the first set of blocks, wherein the cache further generates a fault map which identifies a defect in a selected one of the first and second sets of blocks to direct use of the remaining one of the first and second sets of blocks for caching by the controller.

13. The apparatus of claim 12, wherein the cache further comprises a read circuit which decodes the fault map during a read access operation upon the cache.

14. The apparatus of claim 12, wherein the cache further comprises a write circuit which concurrently writes input data to the respective first and second sets of blocks responsive to a data write operation, said input data subsequently output by the read circuit.

15. The apparatus of claim 12, wherein the cache further comprises a decoder circuit which decodes the fault map to identify a defective set of blocks in the buddy cache structure and which decodes a buddy map to identify a corresponding set of non-defective blocks and to which data at a selected tag address are stored.

16. The apparatus of claim 15, wherein the cache further comprises a multiplexor coupled to the decoder circuit which selectively outputs said data from the non-defective blocks responsive to the decoder circuit.

17. The apparatus of claim 12, wherein the RSM cells each comprise a spin-torque transfer random access memory (STRAM) cell.

18. The apparatus of claim 12, wherein the RSM cells each comprise a resistive random access memory (RRAM) cell.

19. A method comprising:
providing a non-volatile resistive sense memory buddy caching structure comprising a first set of blocks in a first location of the structure and a second set of blocks in a second location of the structure;
redundantly writing data to both the first and second sets of blocks so that they mirror each other;
maintaining a fault map and a buddy map wherein the fault map indicates which blocks of said first and second sets of blocks are operational and the buddy map associates the respective first and second sets of blocks to compensate for potential faults; and
outputting data upon a request by decoding the fault map and the buddy map to return the appropriate block data.

20. The method of claim 19, wherein the buddy caching structure is characterized as a cache memory for a controller, the cache memory used to cache data during transfers of said data between a non-volatile data memory array and a host device.
